(19) United States
(12) Patent Application Publication
(10) Pub. No.: US 2012/0006015 A1
(43) Pub. Date: Jan. 12, 2012

(54) FALLING WATER POWER GENERATORS AND POWER GENERATING METHODS

(76) Inventor: Jack Alexander McGillis, Oakland, CA (US)

(21) Appl. No.: 12/890,520

(22) Filed: Sep. 24, 2010

Related U.S. Application Data
(63) Continuation-in-part of application No. 12/626,541, filed on Nov. 25, 2009.

(51) Int. Cl. F03B 13/12

(52) U.S. Cl. 60/502

(57) ABSTRACT

A method for generating power by converting the vertical movement of floats in one or more reservoirs is provided. Each reservoir has an inlet and an outlet. A float is disposed in each reservoir. A shaft is connected to each float. Controls are provided for actuating inlet and outlet gates to cause water to flow into and out of each reservoir via its corresponding inlet and outlet, respectively. As a result, the flowing water moves each float in a vertically oscillating manner to rotate the shaft at an output rate suitable to generate usable power.

### CROSS-REFERENCE TO RELATED APPLICATIONS

This application is a continuation-in-part of prior application Ser. No. 12/626,541, filed Nov. 25, 2009.

### BACKGROUND

1. Technical Field

The present invention relates to apparatuses and methods for generating power from a falling water source. More specifically, the invention relates to apparatuses and methods that use vertical movements of one or more floats in reservoirs containing the floats to rotate a shaft.

2. Related Art

Moving water in one form or another has been used for many years to generate power. Early in human history, for example, water wheels were built to convert energy associated with moving water in rivers into rotational energy, which in turn, were adapted for use for milling grain and later for generating electricity. More recently, the massive hydroelectric generation facilities have been built at Niagara Falls bordering the United States and Canada and at Hoover Dam in Arizona.

In addition, a number of technologies have been proposed to harness energy from tides and waves. For example, U.S. Patent Application Publication No. 20080157532 to Loui et al. describes a marine wave energy conversion system. The energy conversion system includes a first mechanical system for converting reciprocating motion to rotary motion and a second system formed of belts and pulleys connected to said first system. The second system is driven by the rotary motion to lift a weight and allow the weight to return to its original position under the influence of gravity. In addition, U.S. Patent Application Publication No. 20070290508 to Burcik describes a wave motion generator having a bore hole at a coastline of an ocean. The bore hole lower end communicates with the ocean underwater while the upper end is above water level, allowing wave motion within the bore hole. A float disposed within the bore hole may travel along the borehole. A linkage attached to the float converts the motion of the float to rotary motion of a generator shaft so as to induce electric current in the generator.

In short, apparatuses for generation of power from flowing water may take a number of different forms. Some convert vertical motion into usable power. Others translate substantially horizontal motion into other usable forms of energy.

Falling water power generators typically require a water source of a sufficient height drop to permit the generators to extract the energy. Difficulties in extracting energy from a falling water source arise where the height drop is relatively short. Thus, for example, electrical generators known in the art have not been used in conjunction with water sources such as mature rivers flowing down a mild slope or other falling water sources with a relatively small height drop.

Some attempts have been made to overcome this problem. For example, U.S. Patent Application Publication No. 20050023836 to Abdalla describes a variable buoyancy float engine. The engine includes a float tank with variable buoyancy. Due to its variable buoyancy, the tank may be filled to allow the tank to descend to a lower position within a float chamber. Once the tank has descended, it may be then drained to allow it to ascend to a higher position. While such technology may be used to generate power, the low efficiency of such technologies make them economically unfeasible and of questionable utility.

Thus, additional opportunities exist in the art to provide improved falling water power generators and related power generating methods.

### SUMMARY OF THE INVENTION

In a first embodiment, a power generator is provided having one or more reservoirs, typically in aligned relation and at a substantially identical elevation. Each reservoir has an inlet and an outlet. A float is disposed in each reservoir, and each float is vertically movable according to water levels in its reservoir. A shaft is connected individually to each float in a manner that allows vertical movement of the float to rotate the shaft. Controls are provided for actuating each inlet and outlet to cause water to flow into and out of each reservoir via its corresponding inlet and outlet, respectively, in a manner that allows the flowing water to move each float in an oscillating manner. The shaft may thus be rotated at an output rate suitable to generate usable energy.

At a minimum, two floats are typically employed, and the shaft may have the same number of crank throws as floats. In addition, crank throws may be offset angularly and evenly from each other. Thus, when two floats are provided, the crank throws may be offset angularly at 180° from each other.

Additional floats may be employed to provide additional torque to rotate the shaft, and their crank throws may be arranged in different manners. For example, when X crank throws are provided, they may be offset angularly at 360°/X from each other. Thus, in embodiments of the invention having two crank throws, the crank throws may be offset angularly at 180° from each other. In such a case, the controls may actuate the inlets and outlets in a manner that allows the flowing water to move one float in an opposing, synchronized and reciprocating manner relative to the other float. Similarly, when three crank throws are provided, the crank throws may be offset angularly at 120° from each other. In the alternative, some crank throws may be aligned with others such that the crank throws may not all be offset angularly at 360°/X from each other.

In any case, each float may be connected in a pivoting manner to a crank throw of the crank shaft via a connecting rod. The shaft may be located above the floats, and the connecting rods may be pivoted to centers of upper surfaces of the floats. An optional continuity motor engaged with the shaft may be used to prevent mechanical rotation lockup thereof.

The controls may vary as well. For example, the controls may actuate the inlets and outlets through electronic, mechanical, and/or other means. The actuation may be keyed to water levels in the reservoirs and or positions of the floats. Electro-optical sensors, for example, may be used to detect the water levels and/or positions of the floats in the reservoirs.

Typically, the generator may be used to generate usable power, such as electricity, with a vertical water drop distance of three feet or more. Thus, each reservoir typically has a height of at least about three feet. In addition, the floats may be movable within the reservoirs to exhibit a vertical displacement of at least about three feet.

In another embodiment, the invention provides a method for generating power. One or more reservoirs may be provided with each reservoir having an inlet and an outlet. The inlets are positioned in fluid communication with an upstream source of water. A float is placed in each reservoir such that each float is vertically movable according to water levels in the reservoirs. The floats are connected to a shaft in a manner that allows for vertical movement of the floats within the reservoir to rotate the shaft. The inlets and outlets may be actuated, in a manner responsive to vertical float movements to cause water to flow into the reservoirs via the inlets and out of the reservoirs via the outlets. As a result, flowing water moves the floats in an oscillating manner, thereby rotating the shaft at an output rate suitable to generate usable energy. For example, when the lower water level of the reservoirs is located at an elevation of at least about 3 feet below the upstream source of water, the shaft may rotate with sufficient torque to generate useable energy.

In a further embodiment, an energy converter is provided having one or more reservoirs, each reservoir having an inlet and an outlet. A vertically movable float is disposed in each reservoir. A water source is located at least partially above the reservoirs in fluid communication with the inlets and is capable of delivering water to the inlets at a predetermined rate. The floats and a shaft are connected. Controls keyed to the predetermined water delivery rate actuate the inlets and outlets to cause water to flow into the reservoirs via the inlets and out of the reservoirs via the outlets. As a result, the flowing water moves the floats in a coordinated and oscillating manner, thereby rotating the shaft and converting vertical float movement into rotational energy.

### BRIEF DESCRIPTION OF THE DRAWINGS

FIG. 1 is a three-dimensional view of various moving parts for an exemplary generator of the invention having a two-float configuration.

FIG. 1A is a three-dimensional view of reservoirs for the generator of FIG. 1.

FIG. 2 is an end elevation view of the generator of FIG. 1

FIGS. 3A to 3G are side elevation views showing various rotational positions for the first float of the generator of FIG. 1, FIG. 3A being taken on lines 3A-3A of FIG. 2, and FIG. 3D on lines 3D-3D of FIG. 5.

FIGS. 4A to 4F are side elevation views showing various rotational positions for the second float of the generator of FIG. 1, FIG. 4A being taken on lines 4A-4A of FIG. 2, and FIG. 4D on lines 4D-4D of FIG. 5.

FIG. 5 is a top view of the generator of FIG. 1.

FIG. 6A is an end elevation view of an exemplary generator of the invention having a three-reservoir and three-float configuration.

FIG. 6B is a side elevation view of the three-reservoir generator shown in FIG. 6A.

FIG. 7 is a plan view of a two-reservoir parallel system.

FIG. 8 is a plan view of a two-reservoir series system.

### DETAILED DESCRIPTION OF THE INVENTION

Before describing the present invention in detail, it is to be understood that the invention is not limited to specific types of power generators, such as electrical generators, but should be understood to encompass the generation of power in any usable form. It is also to be understood that the terminology used herein is for describing particular embodiments only, and is not intended to be limiting.

In addition, as used in this specification and the appended claims, the singular article forms “a,” “an,” and “the” include both singular and plural referents unless the context of their usage clearly dictates otherwise. Thus, for example, reference to “a float” includes a plurality of floats as well as a single float, reference to “a reservoir” includes a single reservoir as well as a collection of reservoirs, and the like.

In this specification and in the claims that follow, reference will be made to a number of terms that shall be defined to have the following meanings, unless the context in which they are employed clearly indicates otherwise:

The term “connected” is used herein to describe items that are joined to each other, directly or indirectly. For example, a shaft that is “connected” to a float may be in physical contact to the float, e.g., the float physically contacts the shaft, or be indirectly joined to the float, e.g., the float does not physically contact the shaft.

Similarly, the term “engaged” is used herein to describe items that fit, mesh, interlock or otherwise mechanically conform to each other, directly or indirectly, to ensure coordinated action with each other. Thus, when a continuity motor is “engaged” with a shaft, the motor may directly mesh with the shaft, or be indirectly engaged with the shaft, e.g., via a plurality of interlocking intermediary gears, belts, pulleys, etc.

The terms “generator” or “power generator” are used herein in their ordinary senses and refer to machines, apparatuses, devices or the like, and their component parts, that may be used to convert mechanical energy into another form of energy. One of ordinary skill in the art will recognize that the term “generator” may sometimes be interchangeably used herein with the term “converter” which refers to a machine, apparatus, device, or the like that converts one form of mechanical energy into another.

The term “electrical generator” encompasses mechanical apparatuses used to produce electricity.

The term “substantially identical” as used to describe a plurality of items indicates that the items are identical to a considerable degree, but that absolute identity is not required. For example, when reservoirs are described herein as of a “substantially identical elevation,” the reservoirs may be located at an identical or sufficiently near identical elevation such that any differences are trivial in nature and do not adversely affect the functionality of the reservoirs. The terms “substantial” and “substantially” indicate something else that is essentially the same as the thing referenced.

In general, the present invention relates to power generators including but not limited to electrical generators, energy converters, and related apparatuses and methods. Water is delivered to one or more floats to move them in a vertically oscillating manner. In turn, the vertical movement of the floats is used to rotate a shaft, optionally to generate usable electricity.

Although the invention may employ a single reservoir, two or more reservoirs of substantially identical construction are typically used. A vertically movable float connected to the shaft may be placed in each reservoir. As an upstream water source delivers water to the reservoirs via inlets at a predetermined rate, inlets and outlets of the reservoirs are actuated in a manner that allows the flowing water to move the floats in a coordinated and oscillating manner. In turn, the floats rotate the shaft, thereby converting vertical float movement into rotational energy.

For example, the invention provides electrical power generator that includes one or more reservoirs. Each reservoir has an inlet and an outlet and a float disposed therein. Each float is vertically movable according to water levels in the reservoirs. A shaft is connected to the floats in a manner that allows for vertical movement of the floats to rotate the shaft and generate power as a direct or indirect result of the shaft's rotation. Controls are provided that respond to vertical movement of the floats for actuating the inlets and outlets. As a result, water flows into the reservoirs via the inlets and out of the reservoirs via the outlets in a manner that allows the flowing water to move the floats in a vertically oscillating manner. In turn, the shaft is rotated at a rate suitable to generate usable power, such as electricity.

As another example, the invention provides a method for generating power in which one or more reservoirs are provided. Each reservoir has an inlet positioned in fluid communication with an upstream source of water. Within each reservoir is a float that moves vertically according to water levels in the reservoirs. A shaft is connected to the floats in a manner that allows vertical movement of the floats within the reservoir to rotate the shaft. The inlets and outlets are actuated to cause water to flow into the reservoirs via the inlets and out of the reservoirs via the outlets to move the floats in an oscillating manner. As a result, the shaft is rotated at a rate suitable to generate usable power.

As a further example, an energy converter is provided having one or more reservoirs, corresponding inlets, outlets and floats, and a shaft as discussed above. A water source located at least partially above the reservoirs delivers water to the reservoirs' inlets at a predetermined rate. Controls responsive to the vertical movement of the floats and keyed to the predetermined water delivery rate actuate the inlets and outlets to cause water to flow into the reservoirs to move the floats in a coordinated and oscillating manner. As a result, the shaft is rotated, and the vertical float movement is converted into rotational energy.

In short, the invention operates in a manner somewhat analogous to how an ordinary internal combustion automotive engine operates. Instead of having pistons in cylinders that are driven by combustion initiated by spark plugs, the invention uses floats in reservoirs that are driven by the flow of water controlled by inlets and outlets. The invention in some embodiments converts the floats' linear motion to the shaft's rotational motion in a manner analogous to how the pistons rotate the crankshaft in the automotive engine. In other embodiments, other ways may be used to convert linear motion to rotational energy.

One advantage of the invention over prior art hydropower generation technologies is that the invention is suitable for use with water sources having a relatively shallow height drop, e.g., of approximately three feet. Although hydropower generators, in theory, could have been constructed in the past to operate with such a shallow height drop, the generally accepted wisdom was that such generators would be impractical because of their limited power output in view of their construction expense. In contrast, the invention provides a cost effective and simple apparatus that defies generally accepted wisdom of the past. In any case, the invention can easily be scaled up to include multiple gangs of apparatuses interconnected in series where water flow volume and or vertical height drop permits.

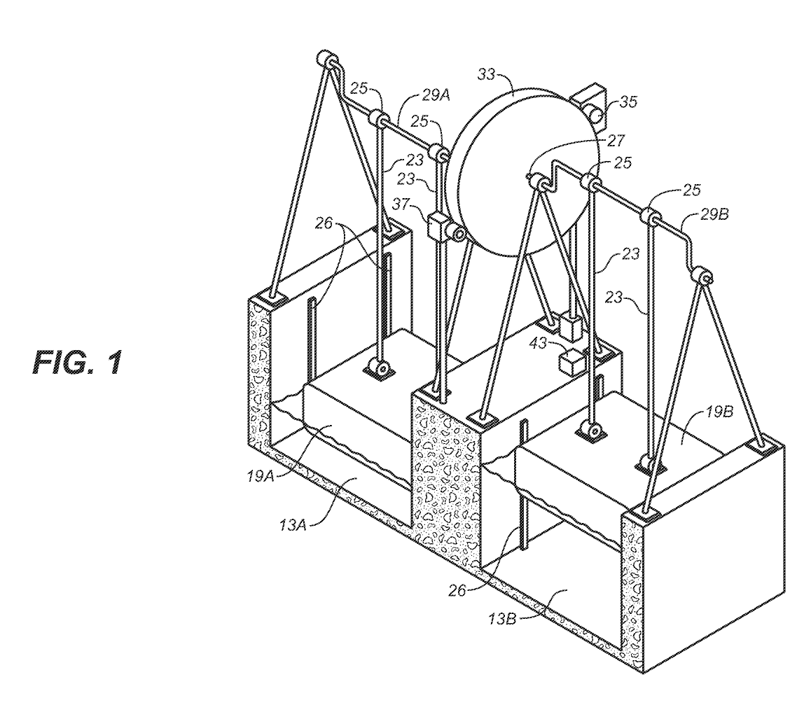

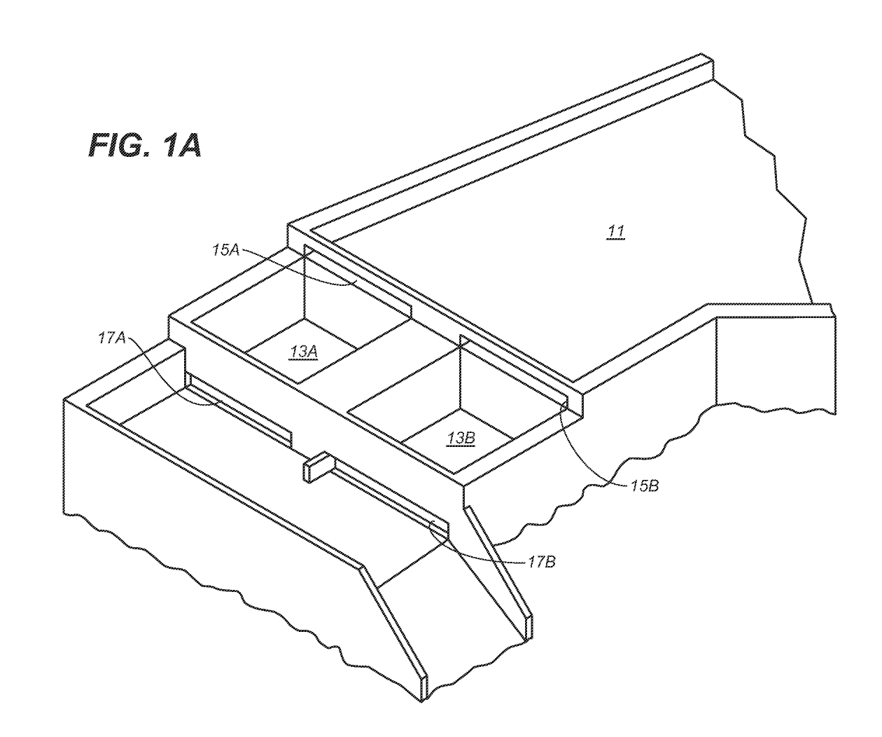

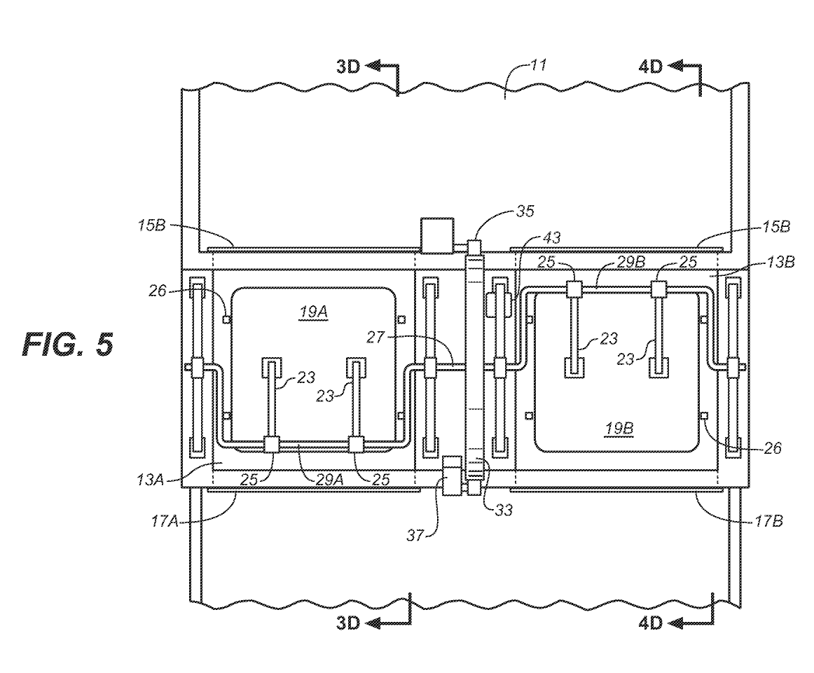

An exemplary two-float generator of the invention is depicted in FIGS. 1-5. As with all figures referenced herein, in which like parts are referenced by like numerals, FIGS. 1-5 is not necessarily to scale, and certain dimensions may be exaggerated for clarity of presentation. As shown in FIGS. 1-5, the exemplary generator of the invention extracts energy from an upstream water source 11. Any water source may be used that can deliver water to the power generator at a predetermined rate suitable for proper functioning of the invention. The minimum rate suitable for practicing the invention may be determined through routine experimentation, but it is expected that even mature rivers may provide a flow rate sufficient for the practice of the invention.

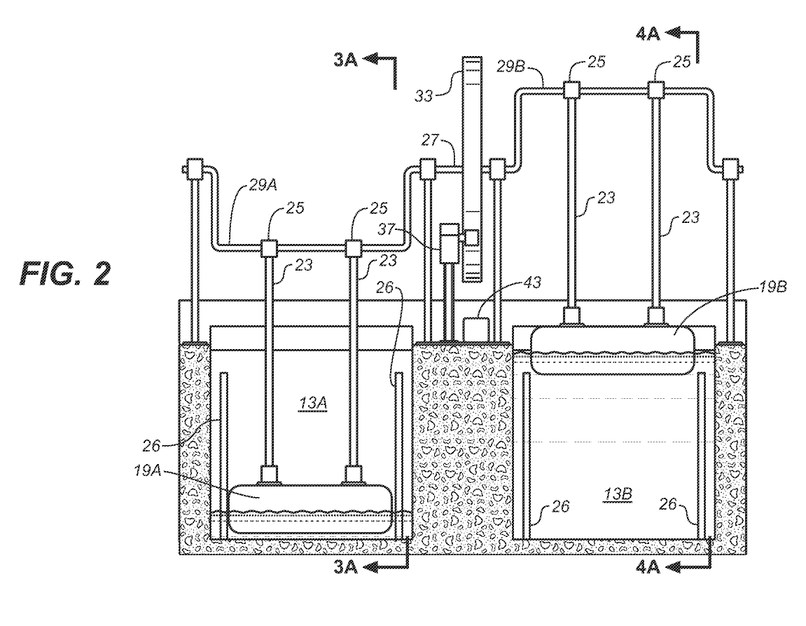

As shown in FIGS. 1A, 3A-3F, 4A-4F, and 5, first and second reservoirs 13A and 13B, collectively referred to as reservoir 13, are located below and downstream from the water source 11. In some cases, as shown in FIGS. 1A and 2, the reservoirs 13 may be located at the same elevation and in aligned relation at a location. However, the invention neither requires reservoirs be aligned nor be located at a substantially identical elevation. In any case, the water levels in the reservoirs 13 are individually controlled by inlets 15 and outlets 17. As shown, inlets 15 and outlets 17 are provided in the form of gates or gate valves that may be raised and lowered, but other forms of inlet and outlets, e.g., ball valves and butterfly valves, may be used as well.

Reservoir construction may be formed from wood, metal, or other construction materials capable of containing water. For ease and practicality of construction, the reservoirs may be formed as substantially identical concrete pits that are optionally square or round in configuration. In any case, the reservoirs should provide a sufficiently large enough water surface area to support the floats next discussed.

Vertically movable floats 19A and 19B, collectively referred to as float 19, are disposed individually in each of the reservoirs 13. The floats may be constructed from any of a number of materials as long as the floats have an overall specific density lower than that of water so as to exhibit appropriate buoyancy for the operation of the invention. As shown, each float 19 has at least one upward projecting connecting rod 23 pivoted along a center line bisecting the float's top surface so that as the float rises and falls with the water level in the reservoirs, the connecting rods 23 are reciprocated vertically. As shown in FIGS. 1, 2 and 4, multiples of connecting rods 23 could be employed if secured to the tops of the respective floats 19 in an aligned wrist pin 25 arrangement whereby the connecting rods 23 operate in unison. A pair of connecting rods 23 with aligned wrist pins 25 is utilized to provide stability to the floats 19. Optional guides 26 further provide stability to the floats by constraining them from uncontrolled rotational and/or nonvertical movement.

As shown in FIGS. 1, 2 and 5, a rotatable shaft in the form of crankshaft 27 is connected to the connecting rods 23 by the wrist pins 25. Although the shaft 27 is shown positioned above the floats 19, the shaft does not have to be located above the floats. Alternatively, the floats 19 may be operatively connected to the shaft 27 via different mechanisms. For example, the floats may be connected to the shaft via belts, pulleys, gears and/or means other than connecting rods. In any case, if connecting rods 23 are used to connect the floats 19 to the shaft 27, they do not have to be connected to the floats 19 at the centers of their upper surfaces. In any case, the crankshaft 27, as shown in FIGS. 1, 2 and 5, has two crank throws 29A and 29B, collectively referred to as crank throws 29, connected to the connecting rods 23. The crank throws 29 are offset angularly 180° from each other. Such an angular offset tends to help prevent rotational lock-up in a two float system such as that shown in FIGS. 1-5.

The 180 offset crank throws 29 may optionally use a continuity motor 37 to prevent rotational lock-up during the brief change of direction from up to down or down to up of the floats 19. A continuity motor is potentially desirable only where the basic cycle of operation puts one float at top-dead-center while the other float is at bottom-dead-center in direct 180 opposition to the first. This only occurs in a system wherein each float is coordinated so that when it is at either top-dead-center or bottom-dead-center all the other floats are simultaneously at either top-dead-center or bottom-dead-center. The simplest example of such a system is a two float system, but rotational lock-up can occur in a system having any number of floats. The continuity motor gear 37 engages a main transfer gear 33 and briefly assists the movement of the main transfer gear during the brief change of direction of the floats 19 to prevent top-dead-center lock-up and/or bottom-dead-center rotational lock-up of the crankshaft 27. The optional continuity motor is less important for systems having more than two floats because such systems can be arranged so that each crank throw 29 is angularly offset from the others by less than 180°. It is anticipated that the crank throws in a system having three or more floats will be arranged to set their angular offset by evenly dividing 360° by the number of floats. For example, a system consisting of three floats could be arranged to position the crank throws to be mutually angularly offset by 120°(360°/3). In such systems neither top-dead-center lock-up nor bottom-dead-center rotational lock-up would be experienced during change of direction of any one of the floats since at least one other float will be providing power to rotate the shaft at those points in the cycle.

As discussed above, controls 43 may be provided for actuating the inlets and outlets. The controls are responsive to vertical movement of the floats to cause water to flow into the reservoirs via the inlets and out of the reservoirs via the outlets in a manner that allows the flowing water to move the floats in a vertically oscillating manner. This may be achieved in a number of ways. For example, the controls may electronically, mechanically, and/or electromechanically actuate the inlets and outlets. In addition, the controls may actuate the inlets and outlets according to water levels in the reservoirs and/or positions of the floats.

Different types of sensors may be used with the controls of the invention. Such sensors may involve mechanical, electrical, and/or optical technologies. Water level sensors 45 and controls 43 may be used to operate inlets 15 and outlets 17 and thereby drive the main transfer gear 33. Coordinated activation of water level sensors 45 and 47 in reservoirs 13 ensures that while the water level in one reservoir is rising, the water level in the other is falling.

In some embodiments, two or more sensors may be provided. For example, upper and lower water level sensors, 45U and 45L, respectively, collectively referred to as sensors 45, may be provided for a first reservoir 13A. The upper water level sensor 45U is in the “exposed” position at almost all times, except briefly, at the highest water level, where the rising water has covered the sensor. At that point, it activates the controls 43 to reverse the condition of the water flow gates 15 and 17, which again exposes the sensor. Conversely, the lower water level sensor 45L is covered almost all of the time, except very briefly, when the water level falls to the minimum, where the sensor is exposed. That condition then activates the controls 43 to reverse the positions of the water flow gates 15 and 17, causing the water level to rise, and eventually cover the sensor 45U.

Alternatively (although not shown) each reservoir may have a set of two sensors. The sensor and controls may be coordinated to assure mechanical synchronization between two reservoir water levels and four water flow gates. In other examples for various numbers of reservoirs, there may be a need for different numbers of sensors and arrangements.

Electro-optic sensors may be used which contain an infrared LED and a light receiver. Light from the LED is directed into a prism, which forms the tip of the sensor. With no liquid present, light from the LED is reflected within the prism to the receiver. When rising liquid immerses the prism, the light is refracted out into the liquid, leaving little or no light to reach the receiver. Sensing this change, the receiver actuates electronic switching within the unit to operate the control circuit.

A number of optional mechanical features ensure that the invention provides rotational movement with sufficient rotational velocity to generate usable energy. For example, a set of gears may be provided to ensure a continuous rotational movement at a sufficient number of rotations per minute to generate usable electricity or other forms of power. In addition, as discussed above, a continuity motor 37 may serve to prevent rotational lock-up.

In operation, controls 43 actuate the inlet gate 15 and outlet gate 17 to cause the rising and falling water levels in the reservoirs to move the floats 19 in a vertically reciprocating manner and thereby the crankshaft 27. The gates 15 and 17, when actuated, allow for inflow and outflow, respectively. These gates generally are in opposite operating position. That is, when one gate is open, the other is closed. During the rising water phase of the cycle, the inflow gate 15 is open and the outflow gate 17 is closed. During the falling water cycle, the inflow gate 15 is closed and the outflow gate 17 is open. The maximum water level and minimum water level sensors 45 in the reservoir 13 are connected to the controls 43, which activate the inflow 15 and outflow gates 17 in both reservoirs, and the continuity motor 37 on the main transfer gear 33.

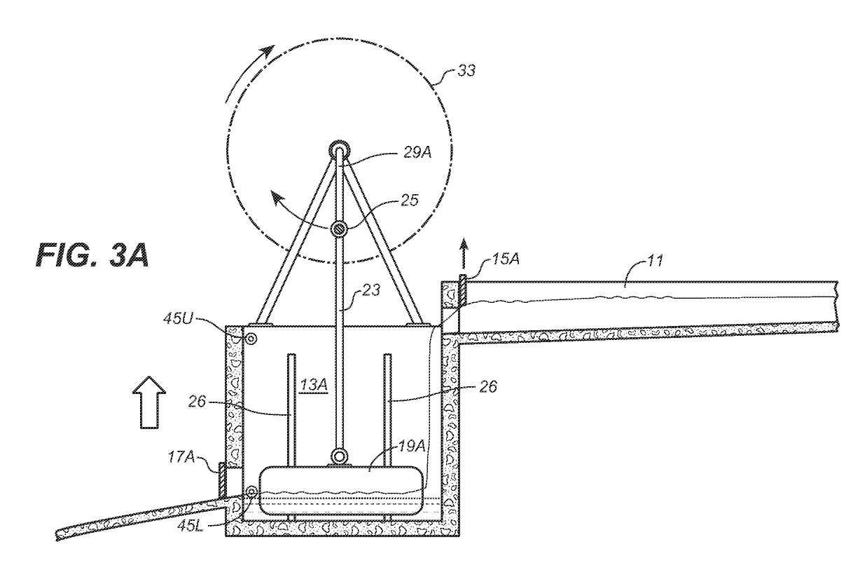

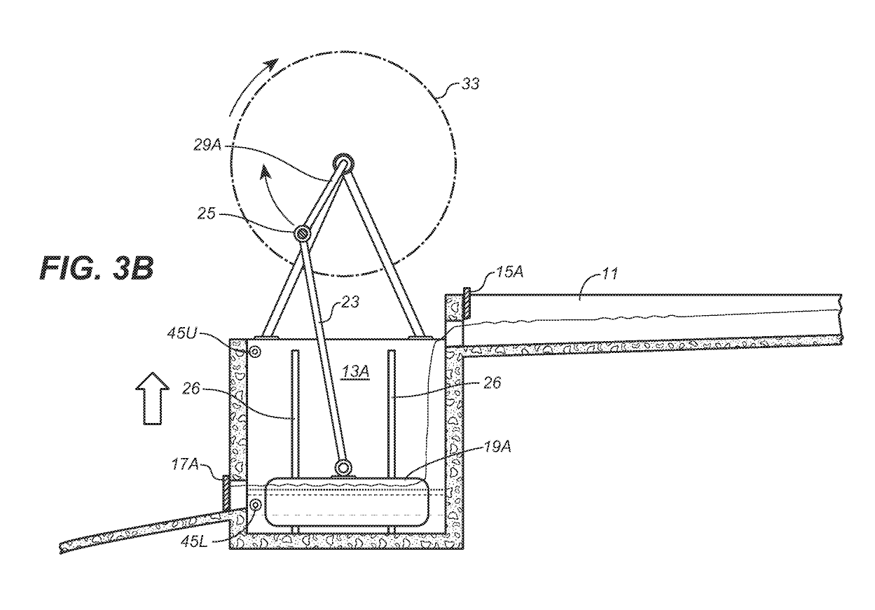

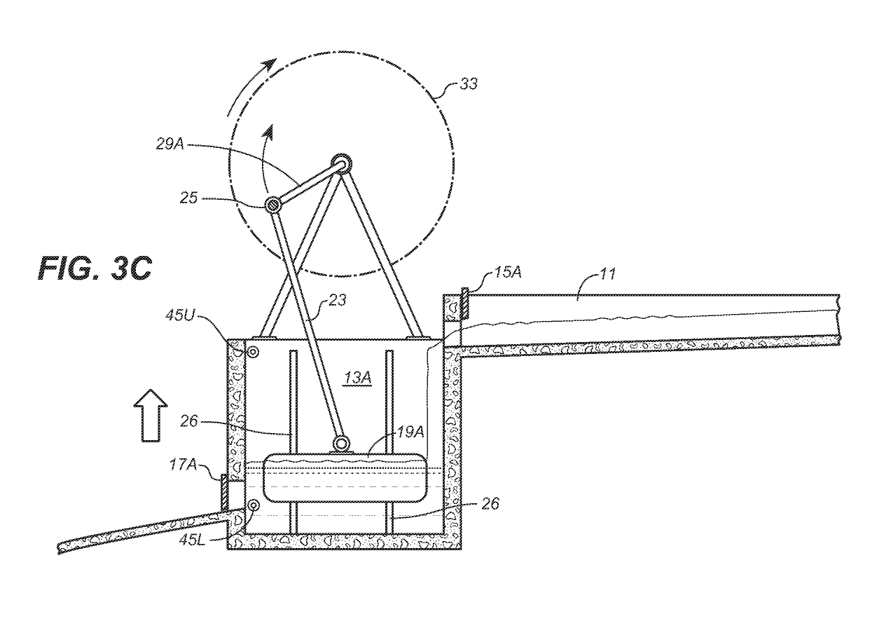

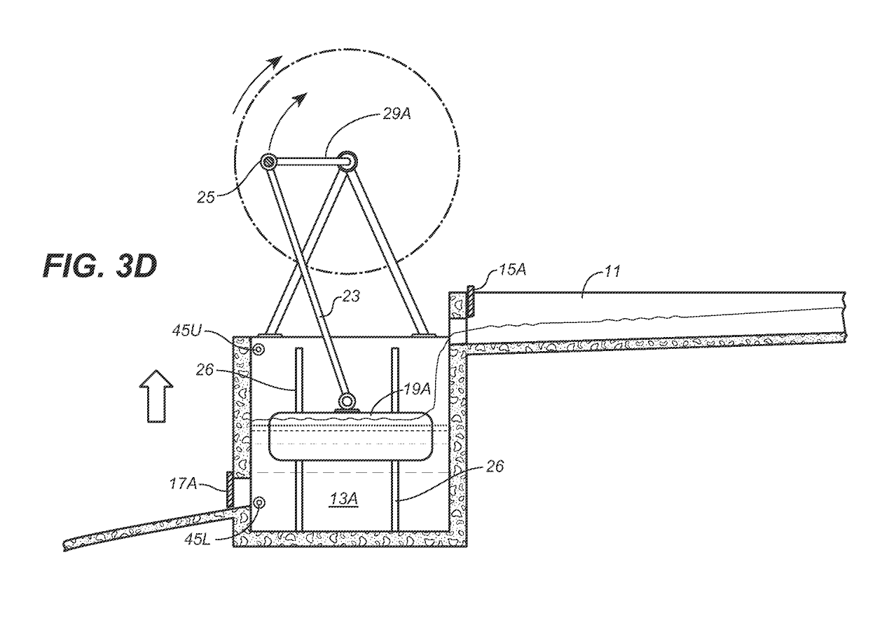

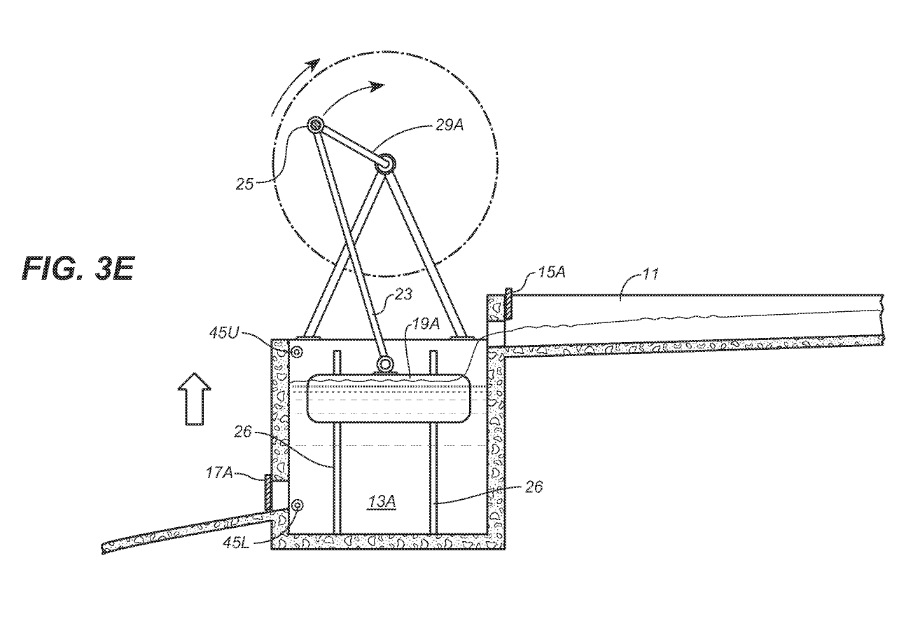

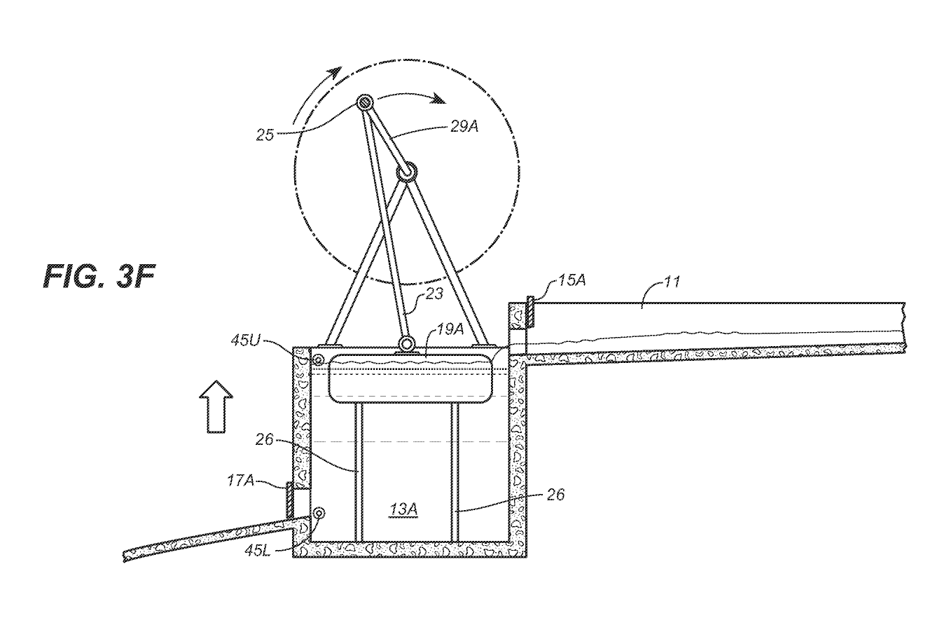

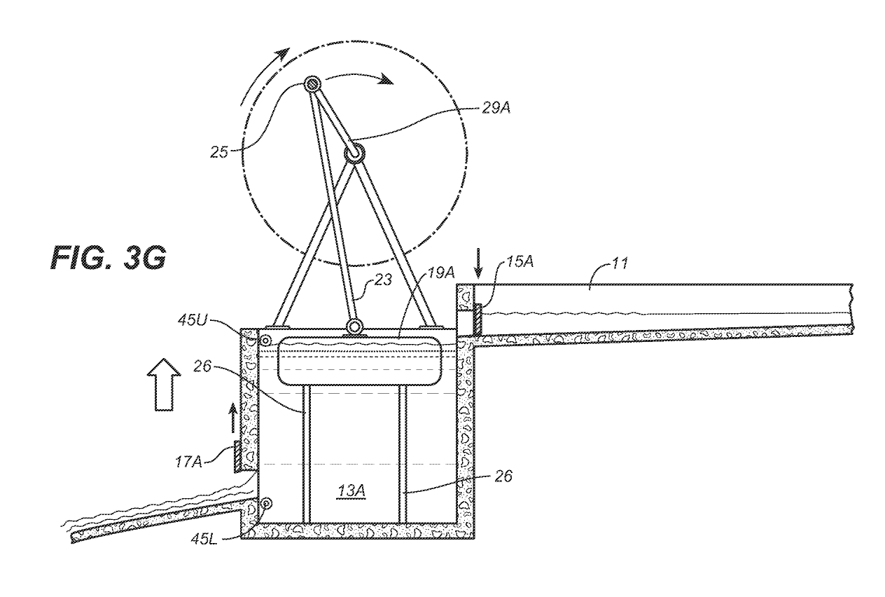

FIGS. 3A-3F show various positions of float 19A within first reservoir 13A throughout the upward power stroke portion of a cycle of operation. In FIG. 3A, water from the upstream source flows through the inlet into the reservoir. When water is rising in the first reservoir 13A, gate 15A is open and outflow gate 17A is closed. As a result, the float rises to an elevated position within the reservoir. In turn, the float raises connecting rod 23, thereby rotating the crank throw toward its uppermost position. See FIGS. 3B-3F.

As the water level rises in the first reservoir 13A, the upper water level sensor 45U is eventually covered with water thus causing the sensor to activate the controls 43. As shown in FIG. 3G, water flow gates 15A, 17A are actuated to reverse their condition from open to closed or the reverse. Additionally, with reference again to FIG. 2, at the time of sensor activation due to maximum water level, the controls 43 also briefly actuate the continuity motor 37 to drive the main transfer gear 33, out of the “top-dead-center” or “bottom-dead-center” position, thus averting possible “lock-up” problems.

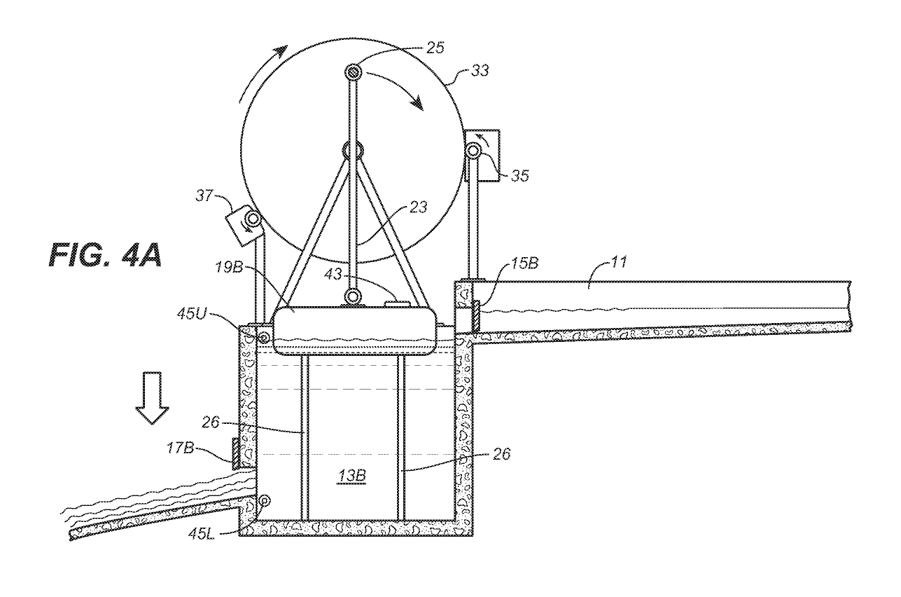

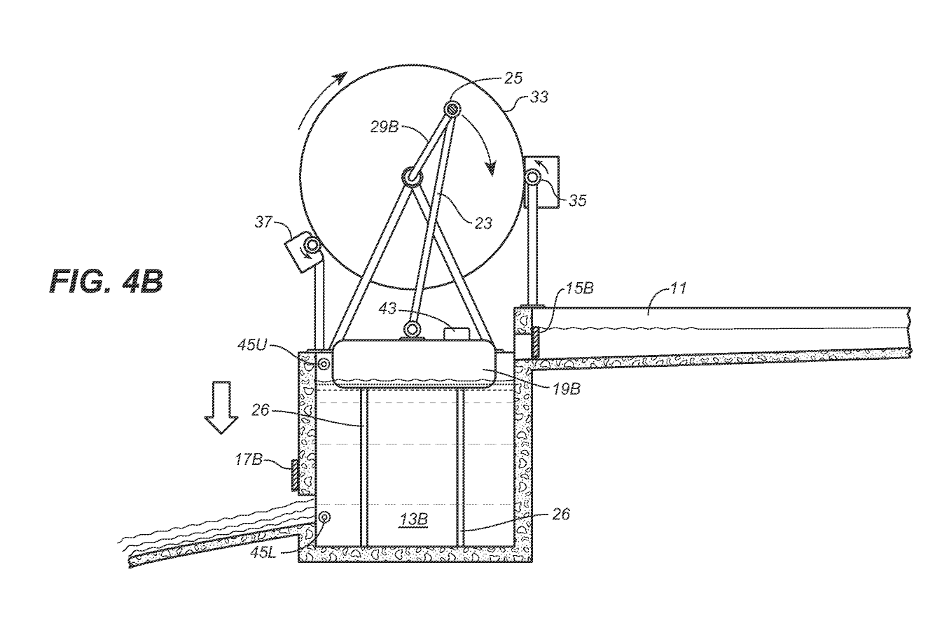

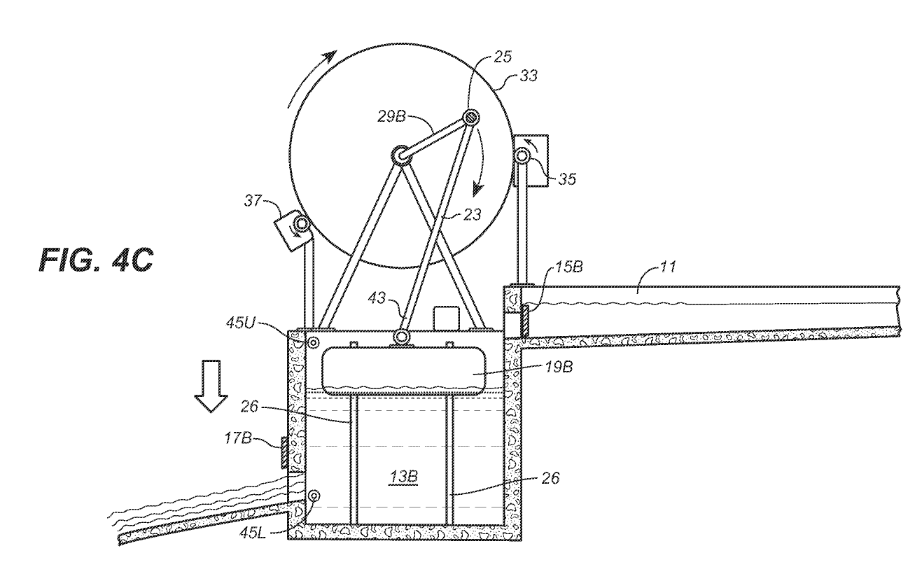

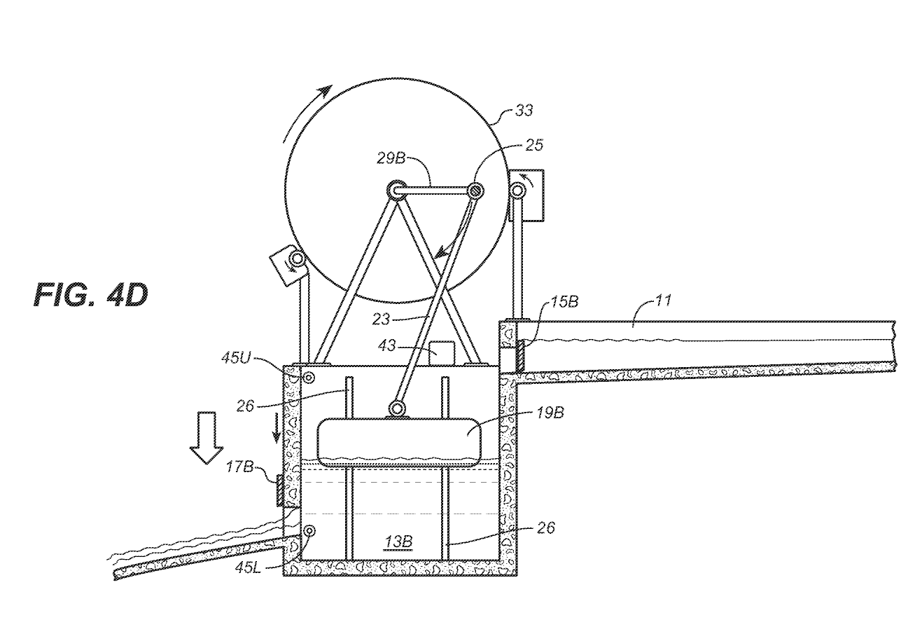

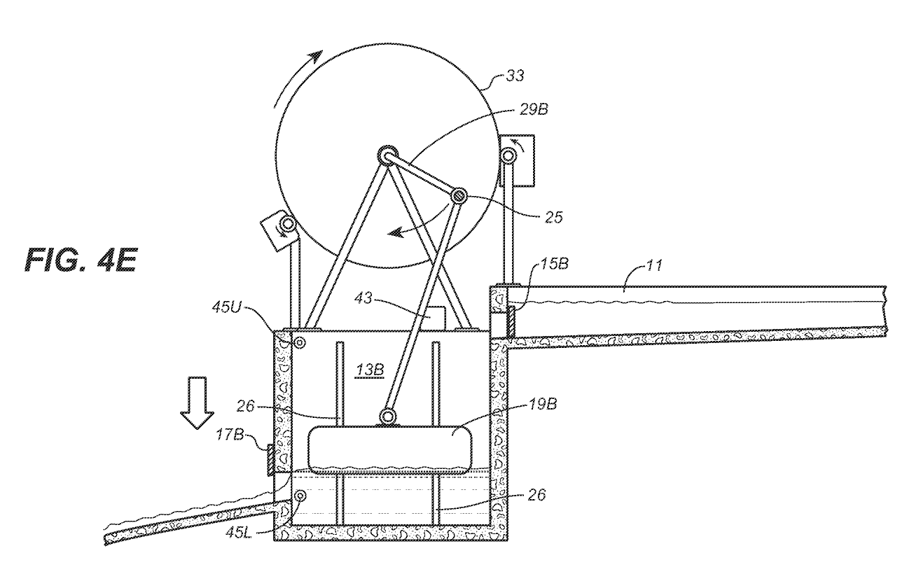

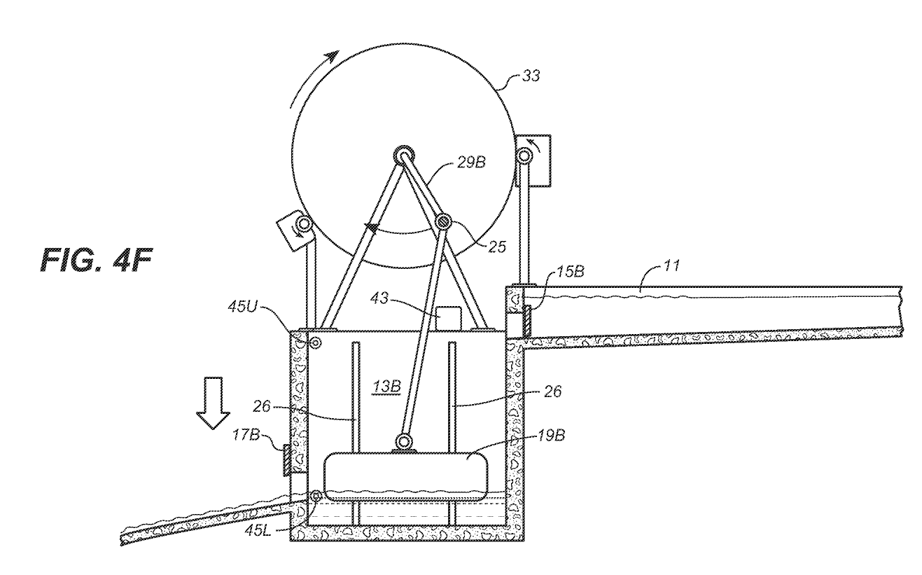

FIGS. 4A-4F show various positions of float 19B within second reservoir 13B throughout the downward return stroke portion of a cycle of operation. FIGS. 4A-4F show the relative positions throughout the downward return stroke of float 19B within second reservoir 13B at the same points in the cycle depicted in FIGS. 3A-3F. As water flows from the reservoir 13B, the float 19B descends toward the bottom of the reservoir 13B. Eventually the water level in the first reservoir 13B reaches the minimum water level thereby exposing the lower water level sensor 45L as shown in FIG. 4F. Sensor 45L then activates the controls 43 to reverse the open or closed position of the water flow gates 15B, 17B, and to also briefly actuate operation of the continuity motor 37 as described above. This causes the water level in the second reservoir 13B to begin rising commencing the power stroke portion of the cycle illustrated with respect to the first float 19A in FIGS. 3A-3F. This cycle repeats continuously.

An important aspect of the invention is that a float which is more deeply submerged in water has greater buoyancy. This upward force is transferred to electrical generating equipment through shaft 27 and primary and secondary transfer gears 33, 35. If, however, another float is at the same time submerged, its buoyancy will resist the buoyancy of the first float, effectively cancelling some portion of the power generated by the first float. In the interest of efficient power generation, it is therefore important, during the power stroke of any one of the floats in a system, to minimize any simultaneous resistance created by other floats in the system.

In one embodiment of the invention, the inlet gates 15 and outlet gates 17 are asymmetrically coordinated, rather than being precisely synchronized to operate in 180° phase opposition, to derive maximum power from each float during its power stroke. Considering again the two float system shown in FIG. 1, maximum power is realized during the upward stroke of a float when it is more deeply submerged in the water since it will then have its greatest buoyancy. To the extent, however, that a second float in the system is also submerged during the upward stroke of the first float, the buoyancy of the second float will resist the buoyancy of the first float thereby frustrating optimal operation of the apparatus. Therefore, increased power may be realized by arranging for each float to be relatively deeply submerged during its upward power stroke while the other float is relatively minimally submerged during its simultaneous downward return stroke. The inlet and outlet gates 15, 17 must therefore be operated so that, when one float is about to commence its power stroke, sufficient water is removed from the reservoir of the other float that it is minimally submerged when the first float commences its power stroke. In a two float system as a practical matter this requires that water be removed at the end of each float's power stroke to “depower” that float so that it changes to passive status during its return phase in preparation for and immediately in advance of the other float entering its power stroke. It will be appreciated by those of skill in the art that so much water could be removed from the reservoir that the float is freed from the water and actually hangs from connecting rod 23. This may be a practical solution but must be within the physical limits of connecting rod 23 and other structural components that would be called upon the suspend the float.

Thus with simultaneous reference to FIGS. 3A-3F and 4A-4F, at the beginning of the power stroke of first float 19A, inlet gate 15A has been opened to admit water into reservoir 13A thereby increasing the buoyancy of first float 19A. At the same time, a sufficient amount of water has been released from reservoir 13B that second float 19B is minimally submerged, thereby reducing its buoyancy, so that it offers little or no resistance to the buoyant power being supplied by first float 19A. See FIGS. 3A and 4A. This state continues, with first float 19A deeply submerged and supplying power while second float 19B is minimally submerged and offering little or no resistance to first float 19A as it progresses upward through its power stroke. Those of skill in the art will understand that the amount each float is submerged can vary, but that the amount second float 19B is submerged during the upward power stroke of float 19A must be less than the amount float 19A is submerged in order to derive power from the power stroke of float 19A. Moreover, this assumes that floats 19A and 19B are the same size and have similar buoyancy properties.

In another aspect of the invention, the buoyancy of each float in a two float system is reduced to a minimum near the end of the power stroke of that float in preparation for the commencement of the power stroke of the other float. Considering FIGS. 3F and 4F, as first float 19A reaches the end of its power stroke, second float 19B is toward the end of its return stroke and nearing the beginning of its power stroke. Therefore, as shown in FIG. 3G, before first float 19A ascends to its highest point, inlet gate 15A is closed and outlet gate 17A is opened to release water from reservoir 13A to reduce its power output as low as possible for the moment when second float 19B reverses its downward direction and commences its upward power stroke at which time outlet gate 17B will be closed and inlet gate 17A opened to admit water into reservoir 13B.

In general, the invention may be used to generate usable power if sufficient torque and rotational speed can be achieved. Numerous factors affect whether usable power may be generated. Such factors include, for example, whether there is a sufficient height drop, the volumetric rate of water flow, the size of the floats, the effective density of the floats, etc.

As an example, the generator shown in FIGS. 1-5 may be suitable for generating usable power when there is a five foot (60 inch) vertical displacement of the floats 19 in the reservoirs 13. That is, the net maximum-to-minimum water level difference inside the reservoirs is five feet. This, in turn, requires that the “diameter of application” for the crankshaft 27 also be 60 inches.

With an exemplary 60 inch diameter of application, crank throws 29 should have an effective length of 30 inches. The crankshaft 27 and the crank throws 29 are used to transfer the reciprocating motion of the floats 19 into the rotational motion of the primary transfer gear 33. The circumference of the main transfer gear 33, noted as the pitch circle in this example, is approximately 13 feet and 3 inches (13.26°) which is 500 inches. This pitch circle contains 1000 gear teeth of one half inch each. The circular pitch of each gear tooth is one half inch. The main transfer gear 33 is engaged with the output gear 35 which has 40 gear teeth with a circular pitch of one half inch each. This produces a pitch circle of 20 inches on the output gear 35. A gear ratio of twenty-five to one (1000 teeth to 40 teeth) is produced. The output gear 35 drives an output shaft which may then connected to electrical generating equipment (not shown).

The crankshaft 27 may be connected to electrical generating equipment through a set of gears 33 and 35. The slow moving main transfer gear 33 needs to convert the output speed at the output shaft to a faster rotational velocity. In this example, the input speed is 4 revolutions per minute (RPM). This yields one full revolution every 15 seconds. Each complete cycle of the piston floats 19 rising and falling takes 15 seconds in this example. The desired output speed to the electrical generating equipment is 100 RPM, which corresponds to 25 revolutions every 15 seconds. A 25-to-1 gear ratio is needed. In this example the 100 RPM speed is an example of a usable speed for typical electrical generation equipment. Other output speeds may be utilized for various other types of power generation.

It should be apparent that an appropriate volumetric flow rate may be calculated for the above example. The invention may generate power at different levels depending on the volumetric flow rate used.

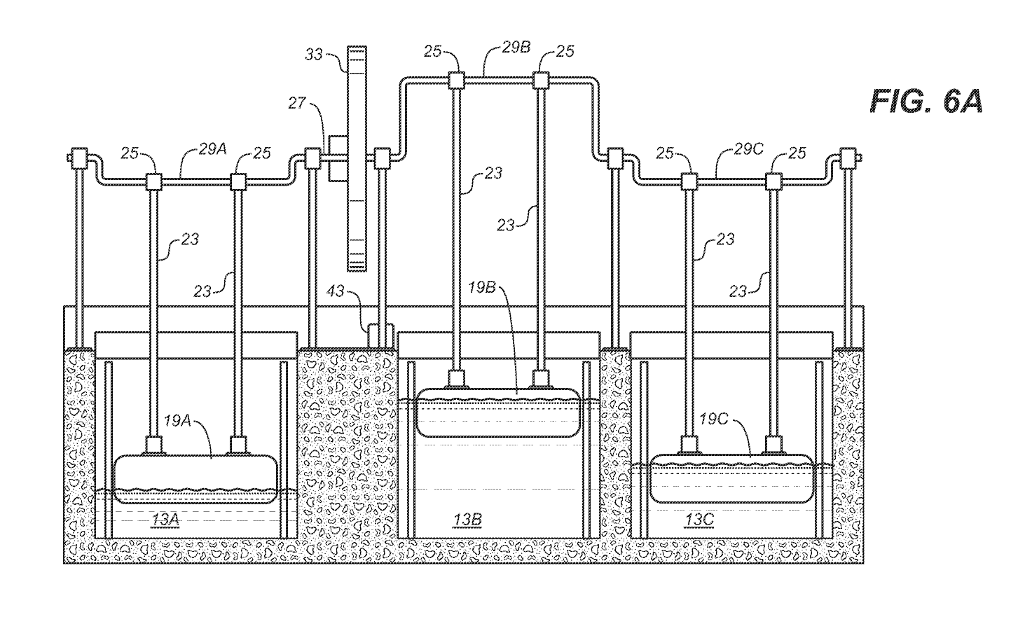

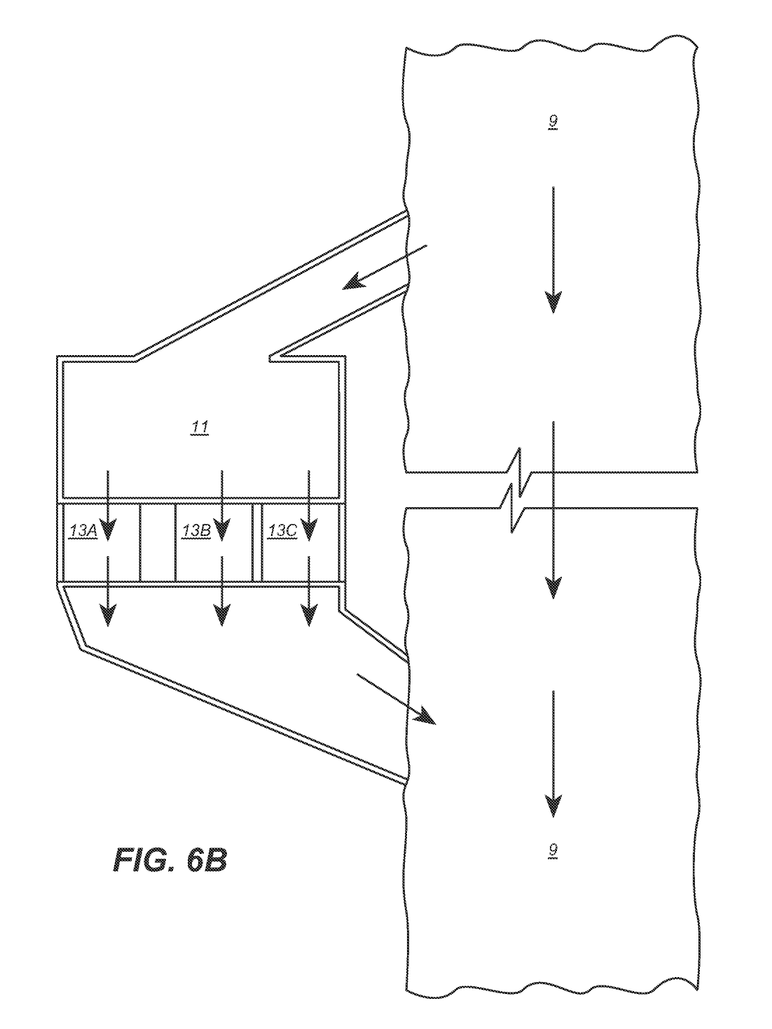

Optionally, one or more additional reservoirs and floats may be used. For example, the generator shown in FIG. 6 is similar to that depicted in FIGS. 1-5 in that it includes first and second floats 19A and 19B and a crankshaft 27 comprising first and second crank throws 29A and 29B. However, the generator includes a third float 19C disposed in third reservoir 13C. The crankshaft 27 also includes a third throw. Like the other throws, the third is connected in a pivoting manner to the third float via additional connecting rods 23. The third float and reservoir combination may be used to provide additional torque to the crankshaft.

A 180° rotational offset is not required when three or more reservoirs are employed. When X represents the number of reservoirs employed, X crank throws may be used that are each connected to a float via a connecting rod. The crank throws may be evenly offset angularly from each other at 360°/X. Here, the crank throws are offset angularly at 120° from each other.

From the foregoing, it should be apparent that the invention represents a novel and nonobvious improvement to known hydropower generation technologies. In general, the falling water power generation contemplated according to the present invention departs substantially from the conventional concepts and designs taught and used heretofore, and in doing so, provides apparatuses and methods primarily developed for the purpose of overcoming the problems inherent in harnessing falling water energy from relatively lower vertical fall or drop water source conditions, but it accomplishes the result in a different manner for extracting energy more simply, more conveniently, and more economically.

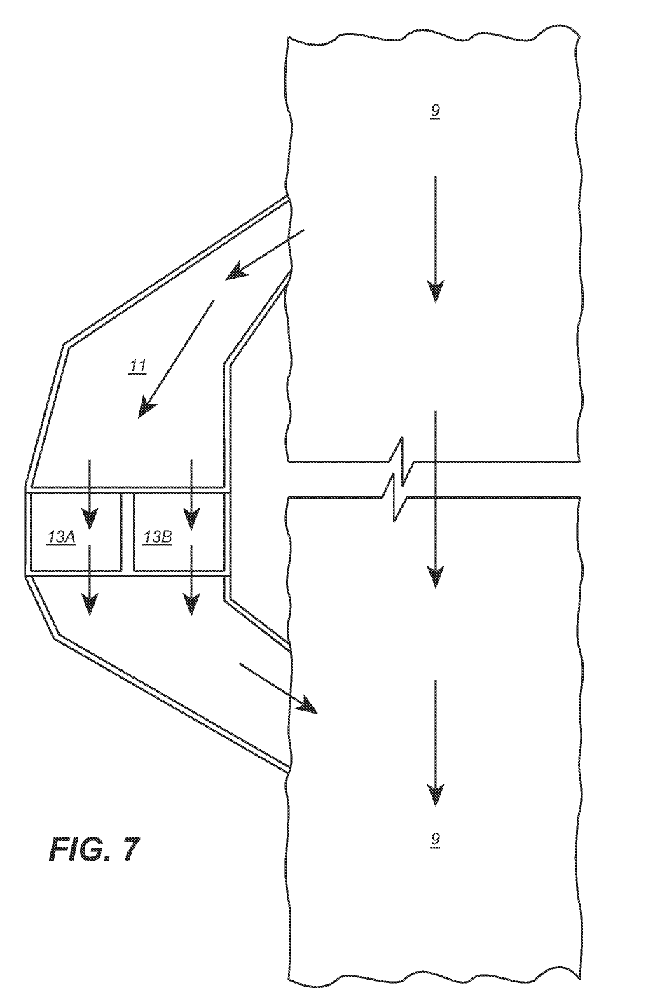

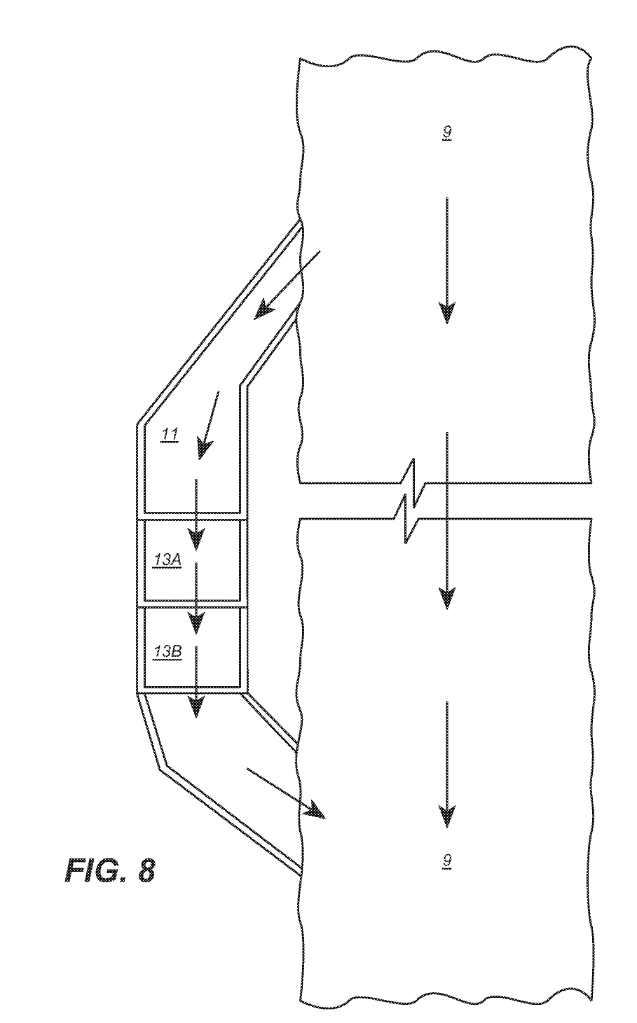

It will be apparent to those of ordinary skill in the art that the invention may be embodied in various forms. For example, the reservoirs may be located in the same elevation in or adjacent to a river in aligned relation across the river. As shown in FIG. 7, the reservoirs 13 may be located downstream from a water source 11 diverted from an adjacent river 9 and in aligned relation with each other at a substantially identical elevation. Alternatively, in a series system shown in FIG. 8, reservoirs 13 may be provided at substantially different elevations. Moreover, the relative orientation of the mechanical components in each reservoir to those in other reservoirs may be adjusted according to need. It will be readily understood that the mechanical linkage used to connect the reservoirs in the parallel systems discussed above will have to be modified to accommodate any differences in elevation between reservoirs in a particular system and any relative differences in orientation of the mechanical components of the reservoirs.

It is to be understood that, while the invention has been described in conjunction with the preferred specific embodiments thereof, the foregoing description is intended to illustrate and not limit the scope of the invention. For example, while the above description has focused on hydropower generation using rivers as a water source, the invention is not limited to using rivers to generate power. The invention may be used in conjunction with locks, e.g., like those used in the Panama Canal. Neither is it intended that the invention be limited to generation of electricity, it being possible to generate power in many different forms. Aspects of different embodiments of the invention may be included or excluded from other embodiments. Other aspects, advantages and modifications within the scope of the invention will be apparent to those skilled in the art to which the invention pertains.

All patent applications mentioned herein are hereby incorporated by reference in their entireties to an extent not inconsistent with the above.

What is claimed is:

1. A method for generating power using water comprising:
closing an outlet gate associated with a first reservoir,
opening an inlet gate associated with said first reservoir to admit into and fill said first reservoir with water,
closing said inlet gate to stop admitting water into said first reservoir,
opening said outlet gate to release water from said first reservoir,
moving a first float vertically in said first reservoir in response to the level of water in the reservoir,
rotating a shaft in response to the vertical movement of said first float at a rate suitable for generating usable power.

2. The method for generating power of claim 1 further comprising:
opening said inlet gate simultaneously with closing said outlet gate.

3. The method for generating power of claim 2 further comprising:
opening said outlet gate simultaneously with closing said inlet gate.

4. The method for generating power of claim 1 further comprising:
opening said outlet gate to release water from said first reservoir during upward movement of said first float to decrease buoyancy of said first float to a minimum no later than when said first float has ascending to its highest point.

5. The method for generating power of claim 1 further comprising:
closing a second outlet gate associated with a second reservoir,
opening a second inlet gate associated with said second reservoir simultaneously with closing said second outlet gate to admit into and fill said second reservoir with water concurrently with water being released from said first reservoir,
moving a second float vertically in said second reservoir in response to the level of water in the second reservoir,
rotating said shaft in response to the vertical movement of said second float.

6. The method for generating power of claim 5 further comprising:
filling said first reservoir at a rate to maximize the buoyancy of said first float, and
releasing water from said second reservoir at a rate to minimize the buoyancy of said second float concurrently with filling said first reservoir.

7. The method for generating power of claim 5 further comprising:
releasing water from each of said first and second reservoirs during upward movement of each one of said first and second floats to reduce the buoyancy of said one float when it has ascending to its highest point to less than the buoyancy of the other float when the other float is ascending.

8. A method for generating power comprising:
closing one of a plurality of outlet gates, each of said plurality of outlet gates associated with one of a plurality of reservoirs,
opening one of a plurality of inlet gates to admit into and fill one of said plurality of reservoirs with water, each of said plurality of inlet gates associated with one of said plurality of reservoirs,
closing said one inlet gate to stop admitting water into said one reservoir,
opening said one outlet gate to release water from said one reservoir,
moving a float vertically in each of said plurality of reservoirs in response to the level of water in the reservoirs,
rotating a shaft in response to the vertical movement of said floats at a rate suitable for generating usable power.
